(19) United States
(12) Patent Application Publication
(10) Pub. No.: US 2003/0223831 A1
(43) Pub. Date: Dec. 4, 2003

(54) Methodology and tool design for high speed machining

(76) Inventors: Daniel V. Viens, Mansfield Center, CT (US); Peter Ryall Fitzpatrick, Chatham, MA (US); Tahany El-Wardany, Dundas (CA); Stephen Varanay, Guilford, CT (US)

Correspondence Address: CARLSON, GASKEY & OLDS, P.C., 400 WEST MAPLE ROAD, SUITE 350, BIRMINGHAM, MI, 48009, US

(21) Appl. No.: 10/161,264

(22) Filed: Jun. 3, 2002

(51) Int. Cl. B23B 51/02

(52) U.S. Cl. 408/60

(57) ABSTRACT

A tool design methodology is provided for high speed machining tools for titanium alloys. The methodology includes providing a predetermined cutting criteria such as cutting speed and cutting depth. The geometry of the tool and work piece is modeled and discretized into desired sections. Cutting parameter such as instantaneous chip load per section and three dimensional forces per section are calculated. The heat parameters are calculated such as the heat generated on the shear and friction surfaces and the heat transfer across the work piece and tool interface. The temperature at the tool and work piece interface is calculated and the coolant parameters are adjusted to reduce the temperature at the interface. Coolant parameters may include the coolant flow angle relative to the interface, coolant impingement pressure at the interface, and the coolant flow rate at the interface. The temperature at the tool and work piece interface is again calculated to determine the coolant parameters that reduce the temperature thereby extending tool life. A high speed cutting tool may be provided according to the present invention that includes a shaft having a fluid passageway with the shaft being adapted to be secured to a chuck. The passageway terminates in a threaded aperture. A threaded fitting such as a pipe fitting is removably received in the threaded aperture with a nozzle at the end opposite the threaded aperture. The nozzle is in fluid communication with the passageway. The nozzle directs cooling fluid at the insert and work piece interface at a desired rate, pressure, and angle. The nozzle may be adjusted relative to the tool body to change the angle of the coolant upon the tool insert.

### BACKGROUND OF THE INVENTION

This invention relates to high speed machining titanium alloys, and more particularly, the invention relates to a tool and methodology for high speed machining.

High speed machining of titanium alloys is desireable to obtain a maximum material removal rate to achieve rapid cycle times for machining titanium components. The material removal rate has been limited by the tool life which is severly reduced as the material removal rate is increased.

Two approaches have been taken in an attempt to improve high speed machining of titanium in an effort to extend tool life. The first approach involves new tool materials with sufficiently high temperature hardness to withstand the abrasiveness of titanium alloys. The tool materials also provide a chemical inertness so as not to react with titanium at elevated temperatures.

The second approach focuses on controlling the interfacial temperature by using coolant to prevent chemical reactions at the tool/work piece/chip interface. Attempts to control the interfacial temperature have not been successful because the coolant designs and application have been unaffected. One technique provides coolant flow under high pressures that may be between the 6 to 10 ksi through holes formed in the cutting tool inserts. This is not practical since the insert will only be used once, and manufacturing a hole in the insert significantly adds to tooling costs. Furthermore, providing coolant pressure between 6 to 10 ksi does not provide an additional benefit. Data indicates that the affect of coolant pressure on tool wear is negligible above 1.5 ksi coolant pressure. The hole in the insert also may reduce the strength and can lead to premature tool chipping and/or catastrophic failure. Another technique utilizes a through the spindle coolant tool holder in which nozzles direct coolant towards the cutting edges of the inserts. The nozzle diameter is greater than 0.125 inches in diameter. This large diameter reduces the pressure of the coolant jet and significantly reduces the possibility of the coolant to effectively evacuate and/or brake the chips.

Other techniques utilize flood cooling in which low pressure and high volume coolant is directed to an area proximate to the chip. Ultimately investigations of the wear mechanism has uncovered the existence of small cracks near the cutting edge indicating the wear mechanism is not the chemical reaction between the tool insert and work piece, but rather thermal shock. Therefore, what is needed an improved tool and methodology for designing tools capable of high speed machining titanium alloys increasing the material removal rate while maintaining or improving tool insert wear rates.

### SUMMARY OF THE INVENTION AND ADVANTAGES

The present invention provides a tool design methodology for high speed machining tools for titanium alloys. The methodology includes providing a predetermined cutting criteria such as cutting speed and cutting depth. The geometry of the tool and work piece is modeled and discretized into desired sections. Cutting parameter such as instantaneous chip load per section and three dimensional forces per section are calculated. The heat parameters are calculated such as the heat generated on the shear and friction surfaces and the heat transfer across the work piece and tool interface. The temperature at the tool and work piece interface is calculated and the coolant parameters are adjusted to reduce the temperature at the interface. Coolant parameters may include the coolant flow angle relative to the interface, coolant impingement pressure at the interface, and the coolant flow rate at the interface. The temperature at the tool and work piece interface is again calculated to determine the coolant parameters that reduce the temperature thereby extending tool life.

A high speed cutting tool may be provided according to the present invention that includes a shaft having a fluid passageway with the shaft being adapted to be secured to a chuck. A body extends from the shaft with a passageway in fluid communication with the fluid passage. The passageway terminates in a threaded aperture. A tool insert is removably secured to a portion of the body. A threaded fitting such as a pipe fitting is removably received in the threaded aperture with a nozzle at the end opposite the threaded aperture. The nozzle is in fluid communication with the passageway. The nozzle directs cooling fluid at the insert and work piece interface at a desired rate, pressure, and angle. The nozzle may be adjusted relative to the tool body to change the angle of the coolant upon the tool insert.

Accordingly, the present invention provides an improved tool and methodology for designing tools capable of high speed machining titanium alloys increasing the material removal rate while maintaining or improving tool insert wear rates.

### BRIEF DESCRIPTION OF THE DRAWINGS

Other advantages of the present invention can be understood by reference to the following detailed description when considered in connection with the accompanying drawings wherein:

FIG. 1 is a perspective view of a tool machining a work piece generating a chip;

FIG. 2 is a perspective view of the present invention high speed machining tool;

FIG. 3 is a cross-sectional view of the tool shown in FIG. 2 taken along lines 3-3;

FIG. 4 is a perspective view of the present invention tool adapted for use in side milling of titanium components; and

FIG. 5 is a flow chart of the present invention methodology for designing high speed machining tools.

### DETAILED DESCRIPTION OF THE PREFERRED EMBODIMENT

A high speed machining device 10 is shown in FIG. 1. The device 10 includes a tool holder 14 having a tool insert 16 that provides a cutting edge which engages a work piece 12 to remove material from the work piece. The material removal rate is partially defined by the axial depth of cut A and the radial cut of R. High speed machining of titanium alloys significantly decreases the life of the tool insert as the material removal rate increases. To this end, it is important to properly cool the tool/work piece/chip interface during machining to keep the temperature under control such that the tool insert 16 does not wear rapidly.

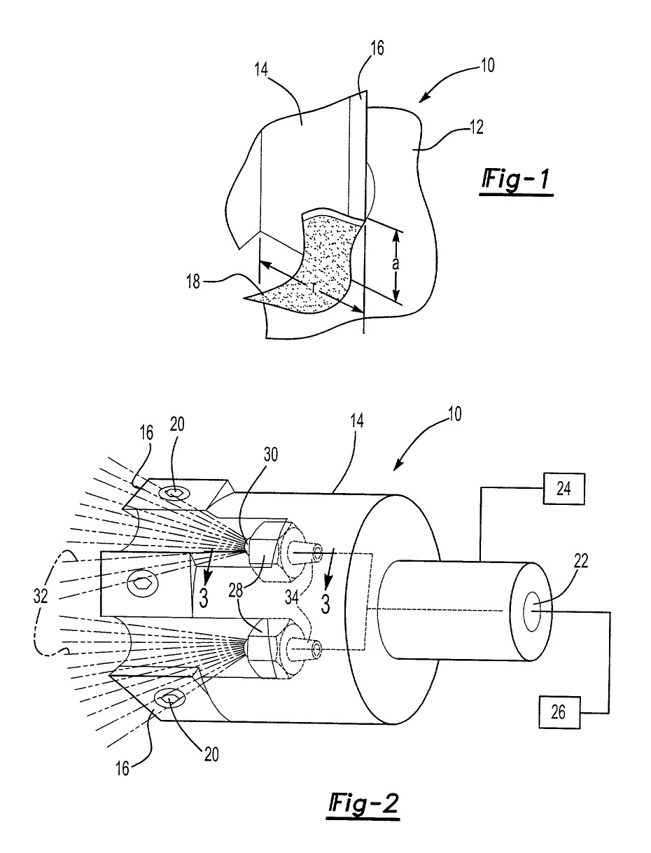

Referring to FIG. 2, a more detailed depiction of the present invention high speed machining device 10 is shown. A shaft extends from the body of the tool holder 14 and is adapted to be received in a chuck of a milling machine, which is schematically depicted at block 24. Pressurized coolant 26 is fed from a source, which is schematically depicted by block 26, through a passageway 22 in the shaft. The passageway 22 is in fluid communication with a threaded aperture 36. A fitting 28 with a threaded end 34 is removable received within the threaded aperture 36. Preferably, the threaded end 34 has pipe threads. Fitting 28 includes a nozzle 30 with an angled passageway 38 directing fluid from the passageway 22 to the nozzle 30 providing a coolant stream 32 on the cutting edge of the tool insert 16. The coolant stream 32 directs coolant onto the tool/work piece/chip interface at a desire pressure, flow rate, and angle to achieve maximum cooling at the interface thereby extending tool life and increasing the material removal rate. The fittings 28 may be rotated relative to the body of the tool holder 14 to achieve a different application angle relative to the tool insert 16.

An end milling tool is shown in FIG. 2. However, it is to be understood that the present invention high speed machining device may also be used for a side milling as shown in FIG. 4. Depending upon the tool insert 16′ multiple nozzles 30′ may be used to provide coolant stream 32′ along the entire length of the tool insert 16′. It is also to be understood that the nozzles 30, 30′ may be integrally formed with the tool holder 14, 14′. The tool inserts are secured to the tool holder 14′ fasteners 20′.

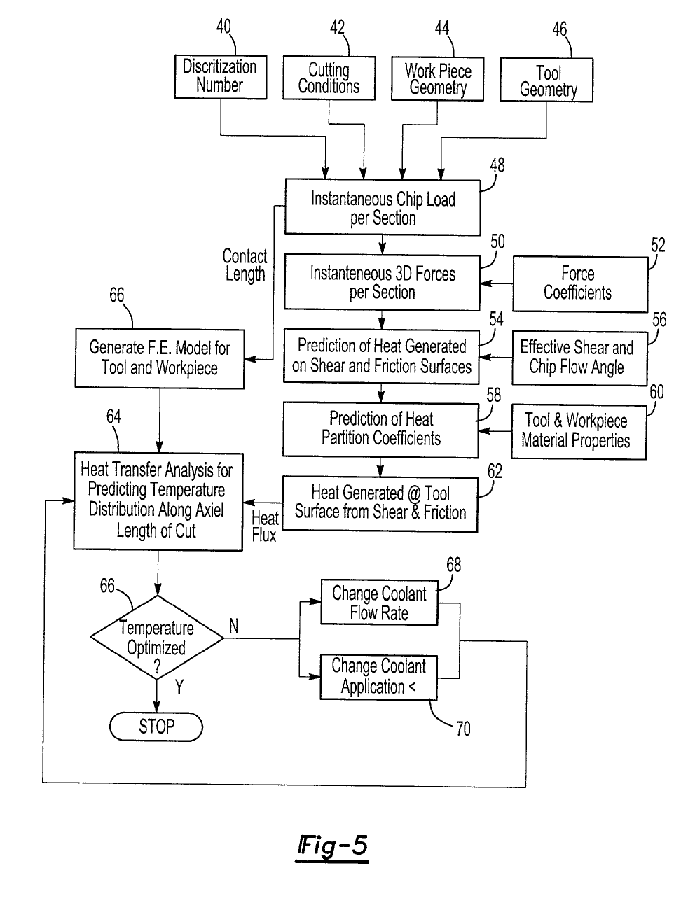

Referring to FIG. 5, a flow chart of the present invention methodology utilized in designing the high speed machining device is shown. Predetermined cutting criteria are provided as cutting conditions, which is schematically indicated at block 42. The cutting conditions may include such parameters as axial cutting depth, radial cutting depth, and cutting speed, which together at least partially define the material removal rate. The geometry of the work piece and tool are modeled, as respectively indicated at blocks 44 and 46. The geometry of tool workpiece intersection is then calculated. The intersected volume are then discretized, as indicated at block 40, to divide the volume into discrete sections. Preferably, the sections are typically cut perpendicularly to the axis of rotation. Within the sectors, the cutting mechanics closely resembles oblique cutting, which simplifies the calculations. The force vectors and temperature distribution is then determined for each sector and added together to obtain a final total, which is discussed in more detail below.

The information is then used to determine the instantaneous chip load per section, as indicated at block 48, which is a function of the cutting conditions and cutting angles. The instantaneous 3D forces per sections are calculated using the chip load at block 50 to predict the instantaneous cutting forces, torque, and power. Cutting force coefficients from block 52, which have been determined experimentally for the specified tool/work piece combination and range of cutting conditions, are fed into block 50.

The parameters are then calculated. The heat generated at the shear and friction surfaces are predicted at block 54 utilizing the effective shear and chip flow angle from block 56.

Preferably, a 3D thermoelastic plastic finite element model is used to define the temperature isotherms along the cutting edge in the cutting zone. The model allows for including non-linear properties of the tool and work piece material. Heat partition coefficients are predicted at block 58. The heat partition coefficients include heat generated at the primary shear zone where the chip is sheared from the work piece. Typically, the primary shear zone accounts for greater than 70 percent of the heat generated. The heat partition coefficient also includes the heat generated on the tool rake due to friction where the chip slides across the tool, and the tool clearance face where the work piece slides across the tool. Simple models often neglect the heat generated at the tool rake and tool clearance face. Tool and work piece material properties from block 60 are utilized to predict the partition coefficients at block 58.

The heat flux is calculated at block 62 by determining the heat generated at the tool surface from shear and friction forces. The instantaneous chip load per section from block 48 is utilized to determine the contact length and generate a finite element model for the tool and work piece interface, as indicated at block 66. The heat flux from block 62 and the finite element model from block 66 are used to determine the heat transfer between the tool, work piece, and chip at the interface for predicting the temperature distribution along the axial length of cut. The temperature along the axial length of the cut determines the tool wear rate and any exposure of the tool insert to thermal shock, which clearly diminishes the tool life.

Initial coolant parameters from the coolant at the tool work piece interface are provided to determine an initial temperature at the interface. The coolant parameters may be interactively adjusted to optimize the temperature at the interface. For example, the coolant flow rate, the coolant flow angle relative to the interface, and the coolant impingement pressure at the interface may be adjusted to obtain a reduced temperature at the interface. These parameters may be adjusted and fed to the heat transfer analysis block 64 until the temperature at the interface is optimized.

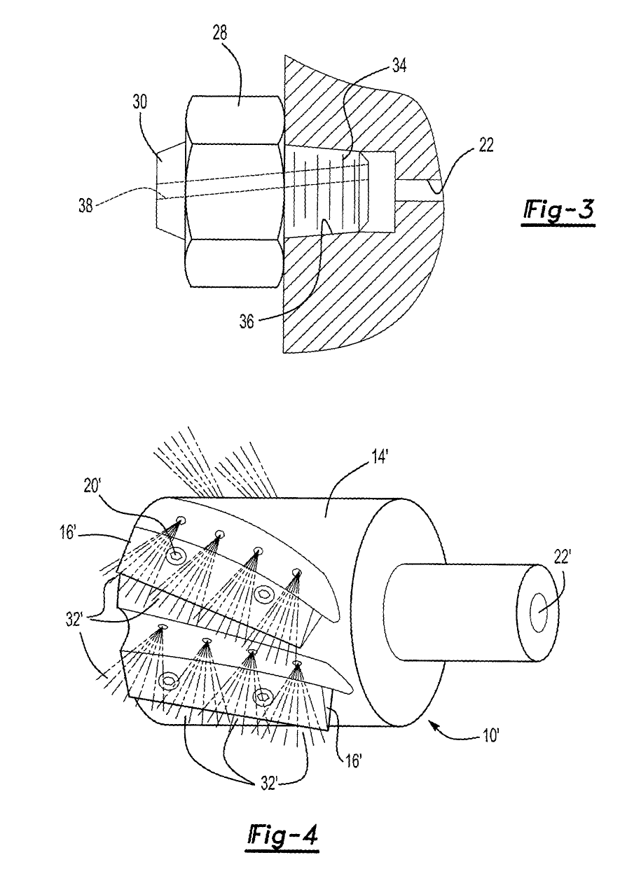

Utilizing the present invention has realized a factor of three increase in cutting speed and a six fold increase in metal removal rate compared to prior tools without detriment to the cutting tool life. Removable and adjustable nozzles as described relative to FIGS. 1-3 may be used to change the angle of the impact impingement point depending on the cutting parameters and the optimize set points predicted by the thermo-mechanical model. The nozzles are replaceable, which permits a change in nozzle shape depending upon the desired cutting conditions. This design enables a change in coolant impingent pressure, jet velocity, and other impingement locations.

The invention has been described in an illustrative manner, and it is to be understood that the terminology that has been used is intended to be in the nature of words of description rather than of limitation. Obviously, many modifications and variations of the present invention are possible in light of the above teachings. It is, therefore, to be understood that within the scope of the appended claims the invention may be practiced otherwise than as specifically described.

What is claimed is:

1. A method of designing a tool for high speed machining comprising the steps of:
a) providing predetermined cutting criteria;
b) modeling the geometry of the tool and work piece;
c) calculating cutting parameters;
d) calculating heat parameters;
e) calculating temperature at the tool and work piece interface; and
f) adjusting coolant parameters to reduce the temperature at the interface.

2. The method according to claim 1, wherein the cutting criteria of step a) includes cutting speed and cutting depth.

3. The method according to claim 1, wherein the modeling of step b) includes discritizing the tool and work piece into desired sections.

4. The method according to claim 3, wherein the calculating of step c) includes calculating the instantaneous chip load per section.

5. The method according to claim 3, wherein the calculating of step c) includes calculating the three-dimensional forces per section.

6. The method according to claim 5, wherein the three-dimensional forces are calculated by using the instantaneous chip load and cutting force coefficients.

7. The method according to claim 1, wherein the calculating of step d) includes calculating the heat generated at the interface.

8. The method according to claim 7, wherein the calculating of step d) includes calculating the heat transfer across the interface.

9. The method according to claim 8, wherein the calculating of step d) includes predicting the heat partition coefficients.

10. The method according to claim 1, wherein the adjusting of step f) includes adjusting the coolant flow rate at the interface.

11. The method according to claim 1, wherein the adjusting of step f) includes adjusting the coolant flow angle relative to the interface.

12. The method according to claim 1, wherein the adjusting of step f) includes adjusting the coolant impingement pressure at the interface.

13. A high speed cutting tool comprising:
a shaft having a fluid passage with said shaft being adapted to be secured to a chuck;
a body extending from said shaft with a passageway in fluid communication with said fluid passage, said passageway terminating in a threaded aperture;
a tool insert removable secured to a portion of said body; and
a threaded fitting removably received in said threaded aperture with a nozzle at an end opposite said threaded aperture in fluid communication with said passageway, said nozzle directing cooling fluid at said insert at a desired rate, pressure and angle.

14. The cutting tool according to claim 13, including a plurality of inserts with at least one fitting directed at each of said inserts.

15. The cutting tool according to claim 13, wherein said fitting includes pipe threads.

16. The cutting tool according to claim 13, wherein said fitting is rotatably adjustable relative to said aperture to direct cooling fluid at said insert at a different desired angle.

17. The cutting tool according to claim 13, wherein said insert includes a cutting edge defining an interface between said insert and a work piece with said cooling fluid directed at said interface.
